(19) United States
(12) Patent Application Publication
(10) Pub. No.: US 2009/0119542 A1
(43) Pub. Date: May 7, 2009

(54) SYSTEM, METHOD, AND PROGRAM PRODUCT FOR SIMULATING TEST EQUIPMENT

(75) Inventors: Teruhiko Nagashima, Kounosu-shi (JP); Hajime Sugimura, Kumagaya-shi (JP)

Correspondence Address: OSHA LIANG L.L.P., TWO HOUSTON CENTER, 909 FANNIN, SUITE 3500, HOUSTON, TX, 77010, US

(73) Assignee: ADVANTEST CORPORATION, Tokyo (JP)

(21) Appl. No.: 11/935,220

(22) Filed: Nov. 5, 2007

(51) Int. Cl. G06F 11/26

(52) U.S. Cl. 714/33; 714/E11.167

(57) ABSTRACT

The simulation method includes a step of measuring a predetermined characteristic from a real device by using test equipment that supplies a test signal to a device-under-test (DUT); a step of saving Response Data generated from measurements obtained by measuring in a file; and a step of verifying activities of a test plan program in a simulation system that simulates the test equipment by using the Response Data saved in the file.

### BACKGROUND OF THE INVENTION

1. Field of the Invention

The present invention relates to a technical field of automatic test equipment (ATE). Specifically, the present invention relates to a technical field of simulating ATE for semiconductor testing.

2. Description of the Related Art

The most part of cost in manufacturing semiconductor is for development and maintenance of a test program for testing an integrated circuit for practicability and functionality. Many hours of operations on actual tester hardware have been needed for the purpose of performing the development and maintenance. That is, a conventional semiconductor tester has little or no ability to simulate a test program. Under such restriction, an engineer is forced to debug his/her test program in the actual tester hardware.

Recently, an emulator for test equipment has been provided. Accordingly, functionality of a test program can be verified without using any high-priced test equipment. For example, U.S. Patent Application Publication No. US 2005/0039079 A1, assigned to the assignee of the present invention, discloses an emulator for simulating a module type test system by using a test program, a vender module and a corresponding device-under-test (DUT).

Recently, many functions have been integrated into one chip, significantly advancing the speed, size and function of a device. That causes a big problem that testing of the device needs to catch up with such trends of advancement and complication in functionality and also needs to improve capacity of analyzing a device to shorten a turn around time (TAT). That causes another big problem that a development period is required to be shorten and a test cost including a tester cost and test time needs to be reduced. Therefore, it is required to amply set an offline simulation environment for test equipment so that a test program can be verified faster at a lower cost.

The present invention is adapted in view of such circumstances. Several aspects according to the present invention intend to implement verification on activities of a test program in an appropriate time period in an offline simulation environment for the test equipment so as to reduce a time period for developing a product. Several aspects according to the present invention intend to implement verification on activities of a test program at a low cost in an offline simulation environment for the test equipment so as to reduce a cost for developing a product.

### SUMMARY OF THE INVENTION

In order to solve the abovementioned problems, a method for simulating test equipment according to the present invention includes: a step of measuring a predetermined characteristic from a real device by using test equipment that supplies a test signal to a device-under-test (DUT); a step of saving Response Data generated from measurements obtained by measuring in a file; and a step of verifying activities of a test plan program in a simulation system that simulates the test equipment by using the Response Data saved in the file. According to the present invention, a Response of a virtual device can be easily created in the offline simulation environment of the test equipment so that the test program can be verified faster at a lower cost.

Preferably, the Response Data includes measurements for one or more characteristics and an output result for a predetermined test item. Also preferably, for the output result, an output result from a real device for the predetermined test item is set by pass/fail. Yet preferably, if the output result is not set in the Response Data, the output result is determined as pass at the step of verifying.

Preferably, the Response Data is generated based on the measurements obtained from one or more real devices.

Also preferably, a step for a user to change the Response Data saved in the file as desired is included.

Yet preferably, for the Response Data, the output results are arranged in a one-dimensional or two or more dimensional matrix for one or more characteristics.

Further, at the step of verifying, activities of the test plan program are verified without loading the pattern program. Preferably, the step of verifying includes a step of loading the Response Data from the file to the simulation system, a step of loading the test plan program to the simulation system, a step of executing the test plan program, and a step of verifying the activities of the test plan program by reproducing the measurement on the simulation system.

The simulation system of the test equipment according to the present invention verifies the activities of the test plan program that is interpreted by the test equipment that supplies a test signal to the device-under-test (DUT). The simulation system includes a file for measuring a predetermined characteristic from the real device by using the test equipment and saving the Response Data generated from the measurements obtained by the measuring; and a framework for verifying the activities of the test plan program by using the Response Data read out from the file.

A computer program product according to the present invention causes a computer to execute each processing step in the simulation method of the test equipment according to the present invention. The computer program of the present invention can be installed or loaded in a computer via various types of recording media including an optical disk such as a CD-ROM, a magnetic disk and a semiconductor memory or by downloading the program via a transmission media such as the Internet. The media for recording or transmitting the program are not limited to those described above. The computer program product, any software and hardware described in the specification form various means for performing functions of the present invention in the embodiment.

In the specification, the term ‘means’ not just refers to physical means by hardware but also refers to functions of the physical means realized by software. Functions of a means may be realized by two or more physical means or functions of two or more means may be realized by a physical means.

The characteristics and advantages of the present invention and their additional characteristics and advantages will be clearly understood by reading the detailed description of the embodiments of the present invention with reference to the drawings below.

### BRIEF DESCRIPTION OF THE DRAWINGS

FIG. 1 is a diagram showing a generalized architecture of a conventional tester;

FIG. 2 shows a system architecture of test equipment 100 according to an embodiment of the present invention;

FIG. 3 is a block diagram showing outlined configuration of a simulation system 120 according to an embodiment of the present invention;

FIG. 4 is a diagram showing a software architecture 200 according to an embodiment of the present invention;

FIG. 5 is a diagram showing a test program compiler according to an embodiment of the present invention;

FIG. 6 is a diagram showing how various types of test instances can be derived from a single test class according to an embodiment of the present invention;

FIG. 7 is a diagram showing an example of a software architecture 700 of an FSM according to an embodiment of the present invention;

FIG. 8 is a diagram showing an example of a software architecture 800 of an LSM according to an embodiment of the present invention;

FIG. 9 is a diagram showing a test flow of a test plan program in an embodiment of the present invention;

FIG. 10 is a diagram showing an example of Response Data for verifying the test plan program shown in FIG. 9 by the LSM;

FIG. 11 is a diagram showing another example of a software architecture 1100 of the LSM according to an embodiment of the present invention;

FIG. 12 is a flowchart showing a flow of processing for reproducing measurements of a real device in an offline environment according to an embodiment of the present invention;

FIG. 13 is a diagram showing an example of an expected value at a point in a device characteristic space that is formed by voltage and frequency according to an embodiment of the present invention;

FIG. 14 is a diagram showing an example of the Response to be injected to an example shown in Table 2; and

FIG. 15 is a diagram showing an example of specifying Fail according to an embodiment of the present invention.

### DETAILED DESCRIPTION OF THE PREFERRED EMBODIMENTS

Embodiments of the present invention will be described below in detail. The same components are numbered the same and redundant description will be omitted. The embodiments below are examples for describing the present invention and do not intend to limit the present invention. Various modifications and applications are possible to the present invention unless departing from the spirit of the invention.

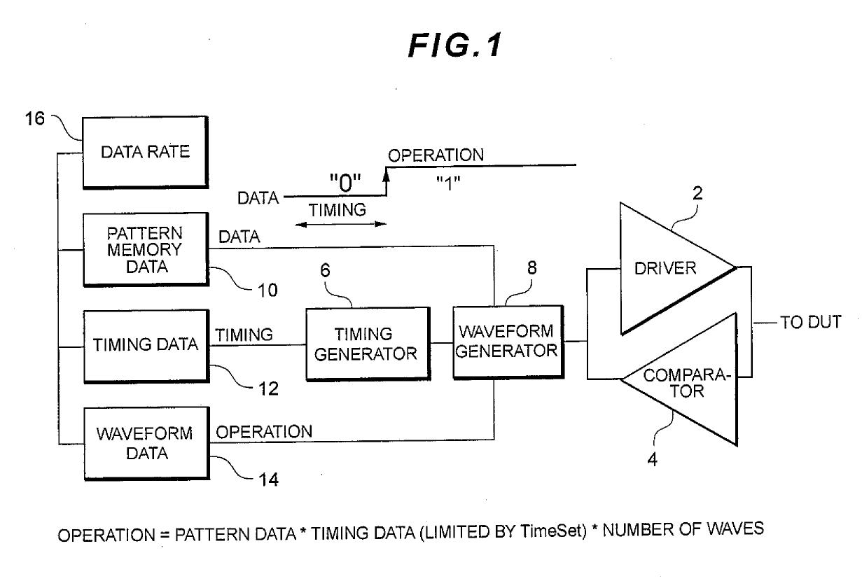

FIG. 1 shows a generalized architecture of a conventional tester that illustrates how a signal is generated and applied to a device-under-test (DUT). Each DUT input pin is connected to a driver 2 that applies test data, while each DUT output pin is connected to a comparator 4. In most cases, tri-state driver-comparators are used so that each tester pin (channel) can act either as an input pin or as an output pin. The tester pins dedicated to a single DUT collectively form a test site that works with an associated timing generator 6, waveform generator 8, pattern memory 10, timing data memory 12, waveform memory data 14, and block 16 that defines the data rate.

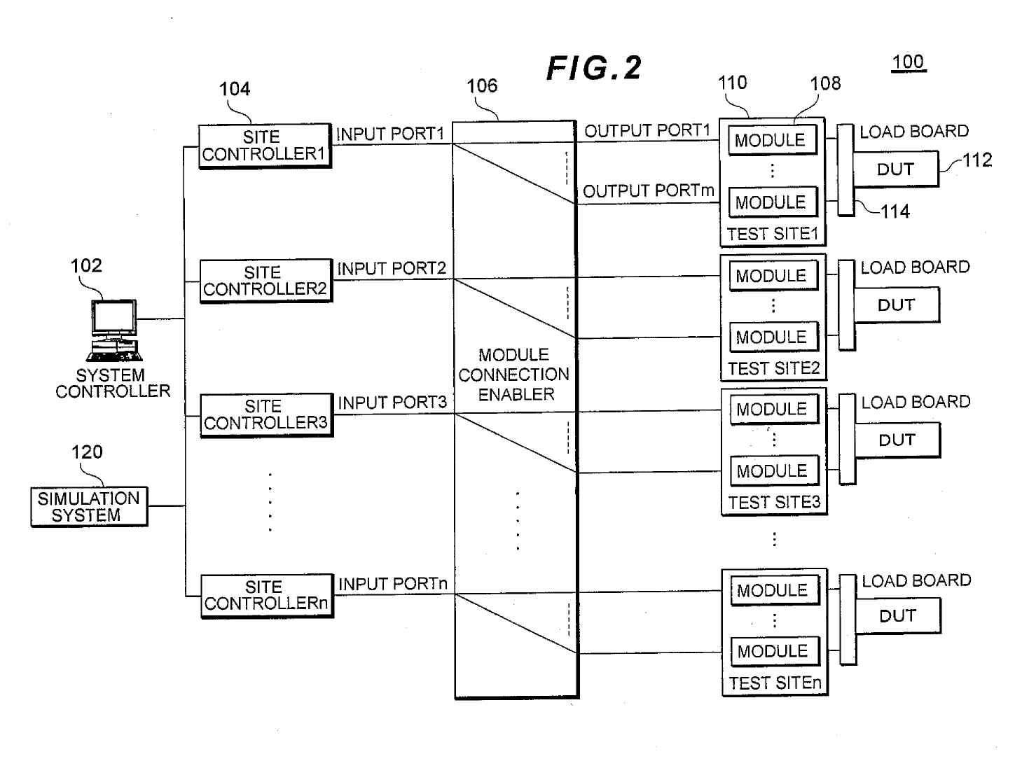

FIG. 2 shows a system architecture of test equipment 100 according to an embodiment of the present invention. The test equipment 100 generates a test signal, supplies it to a DUT 112, and determines whether the DUT 112 is good or bad based on whether a result signal output by the DUT 112 as a result of its activities based on the L test signal matches an expected value or not. The test equipment 100 according to the embodiment is implemented by an open architecture and can use various types of module based on the open architecture as a module 108 that supplies a test signal to the DUT 112.

The test equipment 100 has a simulation system 120 for verifying the activities (debug or the like) of the test plan program (hereinafter, also referred to as ‘test program’) off-line and provides an offline simulation environment (hereinafter, also referred to as ‘offline environment’) that appropriately simulates a real test on the DUT 112 by the simulation system 120. In the embodiment, the simulation system 120 has two kinds of simulation mode such as a full simulation mode (hereinafter referred to as ‘FSM’) and a light simulation mode (hereinafter referred to as ‘LSM’) as simulation environments.

In the embodiment, a system controller (SysC) 102 is coupled to multiple site controllers (SiteCs) 104. The system controller 102 may also be coupled to a network to access files. Through a module connection enabler 106, each site controller 104 is coupled to a test module 108 so as to control one or more test modules 108 located at a test site 110. The module connection enabler 106 allows reconfiguration of connected hardware modules 108 and also serves as a bus for data transfer (for loading pattern data, gathering response data, providing control, etc.). Possible hardware implementations include dedicated connections, switch connections, bus connections, ring connections, and star connections. The module connection enabler 106 may be implemented by a switch matrix, for example. Each test site 110 is associated with a DUT 112, which is connected to the modules of the corresponding site through a load board 114. In another embodiment, a single site controller may be connected to multiple DUT sites.

The system controller 102 serves as the overall system manager. The system controller 102 receives a test control program, a test program, test data and the like that the test equipment 100 uses in testing the DUT 112 via an external network and the like and stores them. The system controller 102 coordinates the site controller 104 activities, manages system-level parallel test methods, and additionally provides for handler/probe controls as well as system-level data-logging and error handling support. Depending on the operational setting, the system controller 102 can be deployed on a CPU that is separate from the operation of site controllers 104. Alternatively, a common CPU may be shared by the system controller 102 and the site controllers 104. Similarly, each site controller 104 can be deployed on its own dedicated CPU (central processing unit), or as a separate process or thread within the same CPU. Depending on the operational setting, the system controller 102 can be deployed on a CPU separate from the operation of the simulation system 120. Alternatively, a common CPU may be shared by the system controller 102 and the simulation system 120.

The system architecture shown in FIG. 2 can be conceptually envisioned as the distributed system with the understanding that the individual system components could also be regarded as logical components of an integrated, monolithic system, and not necessarily as physical components of a distributed system.

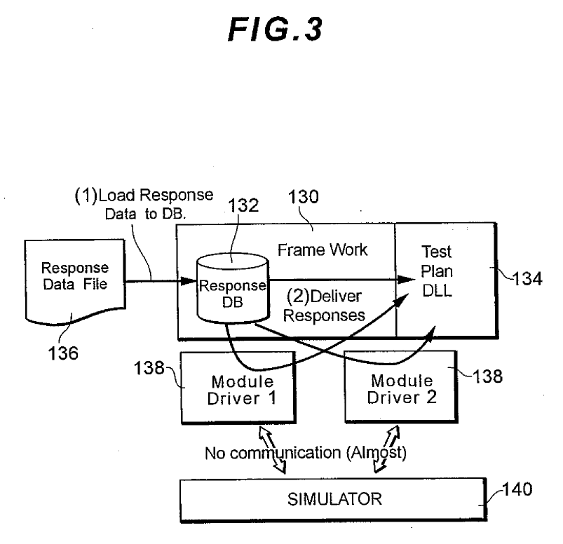

FIG. 3 is a block diagram showing outlined configuration of a simulation system 120 according to an embodiment of the present invention. The simulation system 120 includes a framework 130 for verifying a test plan at the LSM and an emulator 140 for emulating the test equipment 100.

The framework 130 has a Response database (hereinafter referred to as ‘Response DB’) 132 and provides simulation of test executed by the LSM. When the test plan program is to be executed at the LSM, the LSM is first selected for a simulation mode and then the test plan program is loaded. When the test plan program is loaded to the LSM, neither the program nor the pattern needs not to be changed.

In the LSM, the loaded test plan program operates on the framework 130. Here, in the framework 130, the Response Data read out from the Response Data File 136 saved in a storing device is stored in the Response DB 132 in advance, and the data stored in the Response DB 132 acts on a DLL of the test plan program directly or through a Module Driver 138. In such a manner, as the LSM has functions of generating a Response on the simulation system 120 and changing the expected value from outside to the device plan operating on the offline emulator, it can perform verification on the test plan program centering on a test flow in a shorter time than in the FSM.

The emulator 140 includes a controller model, one or more module models, one or more device-under-test models, and a load board model. In order to build a simulation environment, a user generates a system configuration file and an offline configuration file in which a method of connecting a module model, a load board model and a DUT model via the simulation framework is described.

The simulation framework of the emulator 140 provides a load board model, one or more tester channels and one or more DUT channels. The module model is loaded from a dynamic link library (DLL) of a vender. Each block represents a single instance of a module. A plurality of instances in the same module type can be generated as the DLL is loaded for a plurality of times. If the DUT model is written in C++, the DUT model may be provided as the DLL or a Verilog mode.

The load board model can be configured by a user. The user maps a tester channel to a corresponding DUT channel and specifies delay in transfer associated with each connection. All the connections are bidirectional, thus, it needs not to give special consideration to a connector to be specified as an output driver or an input strobe.

A main part of the simulation by the emulator 140 in the FSM is a simulation framework, which is also referred to as a framework. The framework provides two basic services. First, each module can be programmed by the framework virtually the same as in the case where a standard tester is operating via a system bus. By simulating a bus call, the test program can write the emulated module into a register to set up the test. The other service is simulation of test execution. The framework provides a model for physical connection between the emulated module and a DUT model. The framework also provides an engine for maintaining executing sequences of various types of simulation components.

When the test equipment 100 is in the offline simulation mode (offline environment), it replaces a device driver used to communicate with tester module hardware with a software module communicating with the framework via a common memory. In a real tester, communication with the module is facilitated by a hardware module known as bus. The bus uses a command for sending out a binary pattern to an addressable register in the hardware module of the vender. In the simulation, as a particular emulated module is a subject of the framework, the same command is received and interpreted. Then, the framework enables the module to save data in the simulated register by sending out the register address and data to the module. As test program loading is finally divided into a basic unit of a pair of address and data, the simple model supports all dialogs the test program has with the module.

Runtime software differs between the online mode and offline mode only in the system bus device driver, thus, the behavior of the test program in the online environment has high correlation with the corresponding behavior in the offline environment. Therefore, the simulation is correct for the behavior of the user's test program and a fundamental tester operating system (TOS).

The framework also provides a detailed model for a physical connection between the tester module and the DUT. All the connections are modeled as voltage in a wire so that a fundamental physical characteristic is reproduced by the model. As the data format has no presumption in a module/DUT dialog, the framework functions with a combination of an emulation module and a DUT model as far as the emulation module and the DUT model use an application programming interface (API) that is established by the framework. If the two power supplies drive the same wire at the same time, the framework provides automatic adjustment on voltage.

The framework provides various methods for enabling the module of the vender to register and receive an event in the API to control simulation while the test program is executed. The framework controls the executing sequences of the emulated modules and the DUT models by using the events. As the events are managed and some basic rules relating to how the module processes the event are specified, the user of the module type test system can use a flexible template for generating module emulation.

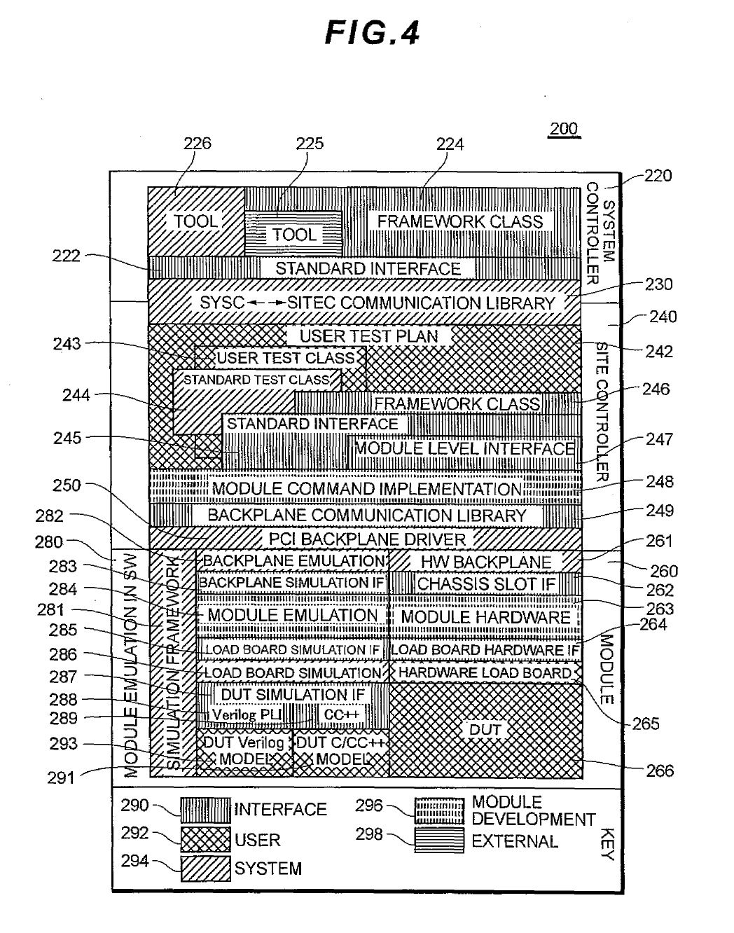

FIG. 4 shows a software architecture 200 according to an embodiment of the present invention. The software architecture 200 represents a distributed operating system, having elements for the system controller 220, at least one site controller 240, and at least one module 260 in correspondence to related hardware system elements 102, 104 and 108. In addition to the module 260, the architecture 200 includes a corresponding element for module emulation 280 in software.

As an exemplary choice, the development environment for this platform can be based on Microsoft Windows. The use of this architecture has side benefits in program and support portability (e.g., a field service engineer could connect a laptop which runs the tester operating system to perform advanced diagnostics). However, for large computer-intensive operations (such as test pattern compiles), the relevant software can be made as an independent entity capable of running independently to allow job scheduling across distributed platforms. Related software tools for batch jobs are thus capable of running on multiple platform types.

As an exemplary choice, ANSI/ISO standard C++ can be taken as the native language for the software. Of course, there are a multitude of options available (to provide a layer over the nominal C++ interfaces) that allows a third party to integrate an alternative language of its own choice into the system to be used.

FIG. 4 illustrates a shading of elements according to their organization by nominal source (or collective development as a sub-system) including the tester operating system, user components 292 (e.g., supplied by a user for test purposes), system components 294 (e.g., supplied as software infrastructure for basic connectivity and communication), module development components 296 (e.g., supplied by a module developer), and external components 298 (e.g., supplied by external sources other than module developers).

From the perspective of source-based organization, the tester operating system (TOS) interface 290 includes: System Controller standard interfaces 222, framework classes 224, Site Controller standard interfaces 245, framework classes 246, predetermined module-level interfaces, backplane communications library 249, chassis slot IF (Interface) 262, load board hardware IF 264, backplane simulation IF 283, load board simulation IF 285, DUT simulation IF 287, Verilog PLI (programming language interface) 288 for DUT's Verilog model and C/C++ language support 289 for DUT's C/C++ model.

User components 292 include: a user test plan 242, user test classes 243, hardware load board 265, and DUT 266, a DUT Verilog model 293 and a DUT C/C++ model 291.

System components 294 include: system tools 226, communications library 230, test classes 244, a backplane driver 250, HW backplane 261, simulation framework 281, backplane emulation 282, and load board simulation 286.

Module-development components 296 include: module commands implementation 248, module hardware 263, and module emulation 284.

External components 298 include external tools 255.

The system controller 220 includes standard interfaces 222, framework classes 224, system tools 226, external tools 225, and a communications library 230. The System Controller software is the primary point of interaction for the user. It provides the gateway to the Site Controllers of the invention, and synchronization of the Site Controllers in a multi-site/DUT environment as described in U.S. Patent No. 60/449,622 by the same assignee. User applications and tools, graphical user interface (GUI)-based or otherwise, run on the System Controller. The System Controller may also act as the repository for all Test Plan related information, including Test Plans, test patterns and test parameter files. The memory storing these files may be local to the system controller or offline, e.g., connected to the system controller through a network. A test parameter file contains parameterization data for a Test class in the object oriented environment of an embodiment of the invention.

Third party developers can provide tools in addition to (or as replacements for) the standard system tools 226. The standard interfaces 222 on the System Controller 220 include interfaces that the tools use to access the tester and test objects. The Tools (applications) 225, 226 allow interactive and batch control to be performed on the test and tester objects. The tools include applications for providing automation capabilities (through, for example, by using SECS/TSEM, etc).

The Communication library 230 residing on the system controller 220 provides the mechanism to communicate with the Site controller 240 in a manner that it is transparent to the user application and the test programs.

The Interfaces 222 resident in the memory relating to the System Controller 220 provide open interfaces to the framework objects that execute on the System Controller. Included are interfaces allowing the Site Controller-based module software to access and retrieve pattern data. Also included are interfaces that applications and tools use to access the tester and test objects, as well as scripting interfaces, which provide the ability to access and manipulate the tester and test components through a scripting engine. This allows a common mechanism for interactive, batch and remote applications to perform their functions.

The Framework Classes 224 associated with the System Controller 220 provide a mechanism to interact with these abovementioned objects, providing a reference implementation of a standard interface. For example, the site controller 240 of the present invention provides a functional test object, for example. The system controller framework classes may provide a corresponding functional test proxy as a remote system controller-based surrogate of the functional test object. The standard functional test interface is thus made available to the tools on the system controller 220. The framework classes effectively provide an operating system associated with the host system controller. They also constitute the software elements that provide the gateway to the Site Controller, and provide synchronization of the Site Controllers in a multi-site/DUT environment. This layer thus provides an object model in an embodiment of the present invention that is suitable for manipulating and accessing Site Controllers without needing to deal directly with the Communication layer.

The site controller 240 hosts a user test plan 242, user test classes 243, standard test classes 244, standard interfaces 245, site controller framework classes 246, module high level command interfaces (i.e., predetermined module-level interfaces 247), module commands implementation 248, backplane communications library 249, and a backplane driver 250. Preferably, most part of the testing functionality is handled by the site controllers 104/240, thus allowing independent operation of the test sites 110.

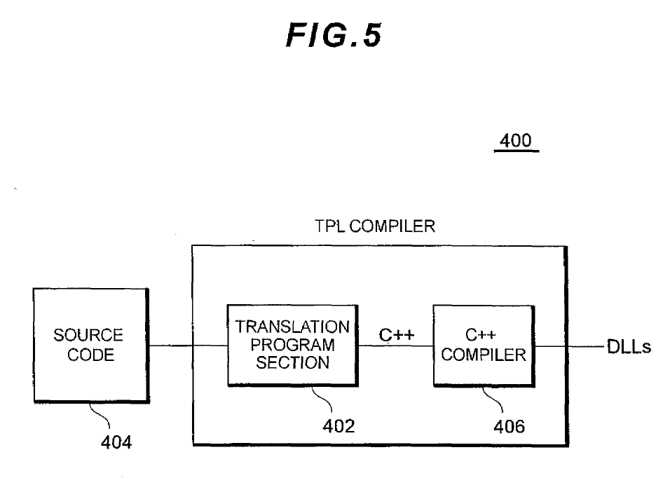

The test plan 242 is written by the user. The plan may be written directly in a standard computer language employing object-oriented constructs, such as C++, or described in a higher level test programming language to produce C++ code, which can then be compiled into the executable test program. For test program development, one embodiment of the present invention employs assignee's inventive Test Program Language (TPL) compiler. Referring to FIG. 5, a test program compiler 400 acts in part as a code generating program including a translating program section 402 to translate a test program developer's source files 404 describing tests and associated parameters into object-oriented constructs, such as C++ code. A compiler section 406, in turn, compiles and links the codes into executable files, e.g., DLLs, to create the test program that may be executed by the tester system. The compiler section may be a standard C++ compiler known in the art.

The test plan creates test objects by using the Framework Classes 246 and/or standard or user supplied Test Classes 244 associated with the site controllers, configures the hardware using the Standard Interfaces 245, and defines the test plan flow. It also provides any additional logic required during execution of the test plan. The test plan supports some basic services and provides an interface to the services of underlying objects, such as debug services (for example, brake-pointing), and accesses to underlying framework and standard classes.

The source code input to the test program compiler 400 includes a Test Plan description file that specifies the objects used in a test plan and their relationship to one another. The file is translated to C++ codes that are executed on the Site Controller in the form of an implementation of a standard interface, which may be denoted ITestPlan. This code is packaged into a Windows dynamic link library (DLL), which may be loaded onto the Site Controller. The Test Program DLL is generated to have standard known entry points that the Site Controller software can use to generate and return the test plan object it contains. The Site Controller software loads the Test Program DEL into its process space and uses one of the entry points to create an instance of the Test Plan object. Once the Test Plan object has been created, the Site Controller software can then execute the test plan.

The Framework classes 246 associated with the site controllers are a set of classes and methods that implement common test-related operation. The site controller-level framework includes, for example, classes for power supply and pin electronics sequencing in a certain order, setting level and timing conditions, obtaining measurements, and controlling test flow. The framework also provides methods for runtime services and debugging. The framework objects may work through implementing the standard interface. For example, the implementation of the TesterPin framework class is standardized to implement a general tester pin interface that test classes may use to interact with hardware module pins.

Certain framework objects may be implemented to work with the help of the module-level interfaces 247 to communicate with the modules. The site controller framework classes effectively act as a local operating system supporting each site controller.

In general, ninety percent or more of the program code is usually data for the device test, and the remaining ten percent of the code realizes the test methodology. The device test data is DUT-dependent (e.g., power supply conditions, signal voltage conditions, timing conditions, etc.). The test code consists of methods to load the specified device conditions onto ATE hardware, and also those needed to realize user-specified objectives (such as datalogging). The framework of an embodiment of the present invention provides a hardware-independent test and tester object model that allows the user to perform the task of the DUT test programming.

To increase reusability of a test code, such code may be made independent of any device-specific data (e.g., pin name, stimulus data, etc.) or device-test-specific data (e.g., conditions for DC units, measurement pins, the number of target pins, name of pattern file, addresses of pattern programs). If code for a test is compiled with data of these types, the reusability of the test code would decrease. Therefore, according to an embodiment of the present invention, any device-specific data or device-test-specific data may be made available to the test code externally, as inputs during code execution time.

In an embodiment of the present invention, a Test Class, which is an implementation of a standard test interface, denoted here as ITest, realizes the separation of test data and code (and hence, the reusability of code) for a particular type of test. Such a test class may be regarded as a ‘template’ for separate instances of itself, which differ from each other only on the basis of device-specific data and/or device-test-specific data. Test classes are specified in the test plan file. Each Test Class typically implements a specific type of device test or setup for device test. For example, an embodiment of the present invention may provide a specific implementation of the ITest interface, for example, FunctionalTest, as the base class for all functional tests for DUTs. It provides the basic functionality of setting a test conditions, executing patterns, and determining the status of the test based on the failed strobes. Other types of implementations may include AC and DC test classes, denoted here as ACParametricTest and DCParametricTest.

All test types may provide default implementations of some virtual methods (e.g., init( ), preExec( ) and postExec( )). These methods become the test engineer's entry points for overriding default behavior and setting any test-specific parameters. However, custom test classes can also be used in test plans.

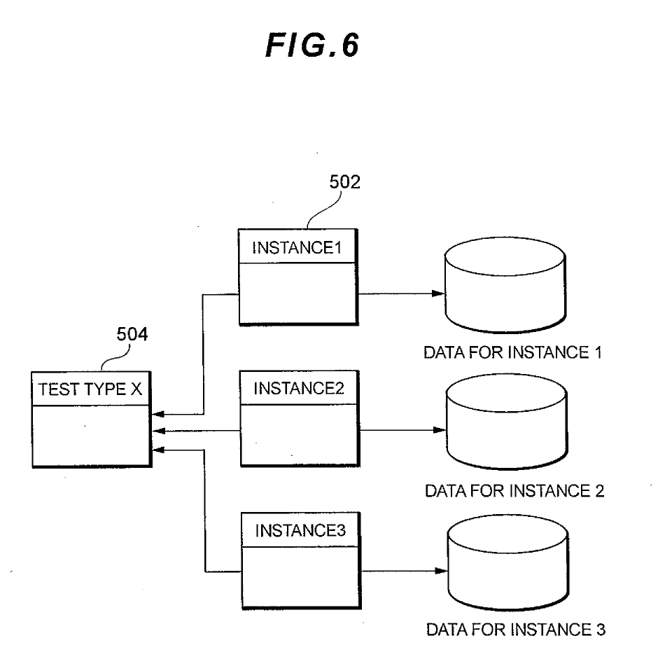

Test classes allow the user to configure class behavior by providing parameters that are used to specify the options for a particular instance of that test. For example, a Functional Test may take parameters PList and TestCondition, to specify the Pattern List to execute, and the Level and Timing conditions for the test, respectively. Specifying different values for these parameters (through the use of different ‘Test’ blocks in a test plan description file) allows the user to create different instances of a Functional Test. FIG. 6 illustrates how different test instances may be derived from a single test class. These classes may be programmed directly in object-oriented constructs, such as C++ code, or designed to allow a test program compiler to take the description of the tests and their parameters from a test plan file and generate corresponding C++ code, which can be compiled and linked to generate the test program. A Template Library may be employed as the general-purpose library of generic algorithm and data structures. This library may be visible to a user of the tester, so that the user may, for example, modify the implementation of a test class to create a user-defined test class.

As to user-developed test classes, an embodiment of the system supports integration of such test classes into the framework in that all the test classes derive from a single test interface, e.g., ITest so that the framework can manipulate them in the same way as the standard set of system test classes. Users are free to incorporate additional functionality into their test classes, with the understanding that they have to use custom code in their test programs to take advantage of these additional facilities.

Each test site 110 is dedicated to test one or more DUTs 112, and functions through a configurable collection of test modules 108. Each test module 108 is an entity that performs a particular test task. For example, a test module 108 could be a DUT power supply, a pin card, an analog card, etc. This modular approach provides a high degree of flexibility and configurability.

The Module Command Implementation classes 248 may be provided by module hardware vendors, and implement either the module-level interfaces for hardware modules, or provide module-specific implementations of standard interfaces, depending on the commands implementation method chosen by a vendor. The external interfaces of these classes are defined by pre-determined module level interface requirements, and backplane communications library requirements. This layer also provides for extension of the standard set of test commands, allowing the addition of methods (functions) and data elements.

The Backplane Communications Library 249 provides the interface for standard communications across the backplane, thereby providing the functions necessary to communicate with the modules connected to the test site. This allows vendor-specific module software to use a Backplane Driver 250 to communicate with the corresponding hardware modules. The backplane communications protocol may use a packet-based format.

Tester Pin objects represent physical tester channel and derive from a tester pin interface, denoted here as ITesterPin. The software development kit (SDK) of an embodiment of the present invention provides a default implementation of the ITesterPin, sometimes referred to as TesterPin, which is implemented in the forms of a predetermined module-level interface, IChannel. Vendors are free to make use of TesterPin if they can implement their module's functionality in the form of IChannel; otherwise, they must provide an implementation of ITesterPin to normally work with their module.

The standard module interface, denoted here as IModule, provided by the tester system of the present invention generically represents a vendor's hardware module. Various vendors may provide various modules. A vendor may provide different modules. Vendor-supplied module-specific software for the system may be provided in the form of an executable file such as dynamic link libraries (DLLs). Software for each module type from a vendor may be encapsulated in a single DLL. Each such software module is responsible for providing vendor-specific implementations for the module interface commands, which comprise the API for module software development.

There are two aspects of the module interface commands: first, they serve as the interface for users to communicate (indirectly) with a particular hardware module in the system, and second, they provide the interfaces that third-party developers can take advantage of to integrate their own modules into the site controller level framework. Thus, the module interface commands provided by the framework are divided into two types:

The first, and most obvious commands, are “commands” exposed to the user through the framework interfaces. Thus, a tester pin interface (ITesterPin) provides methods to get and set level and timing values, while a power supply interface (IPowerSupply) provides methods for powering up and powering down, for example.

In addition, the framework provides the special category of the predetermined module-level interfaces, which can be used to communicate with the modules. These are the interfaces used by framework classes (i.e., “standard” implementations of framework interfaces) to communicate with vendor modules.

However, the use of the second aspect, the module-level interfaces, is optional. The advantage of doing so is that vendors may then take advantage of the implementations of classes such as ITesterPin and IPowerSupply, etc. while focusing on the content of specific messages sent to their hardware by implementing the module-level interfaces. If these interfaces are inappropriate to the vendor, however, they may choose to provide their custom implementations of the framework interfaces (e.g., vendor implementations of ITesterPin, IPowerSupply, etc.). These vendors would then provide the custom functionality that is appropriate for their hardware.

Now, the simulation environment in the test equipment 100 with the abovementioned configuration will be described.

The test equipment 100 in the embodiment has two kinds of simulations mode such as the FSM and the LSM as the simulation environment. The FSM is a conventional test mode executed on the emulator 140 for verifying the test plan program by reproducing the operations of the test equipment 100 including the DUT 112 by the emulator 140. The LSM is a new test mode for verifying the test plan program at a high speed without performing such processing as loading of a pattern file and emulation on the DUT model by arbitrarily controlling the output from the DUT model. Preferably, the user selects the simulation mode to load the test plan program to the simulation system 120.

### (FSM)

The FSM is a conventional simulation mode as described in U.S. Patent Application Publication No. US 2005/0039079 A1 by the same assignee, for example. The FSM provides an emulate environment in which the simulation system 120 appropriately emulates a real test on the DUT 112 in the offline environment.

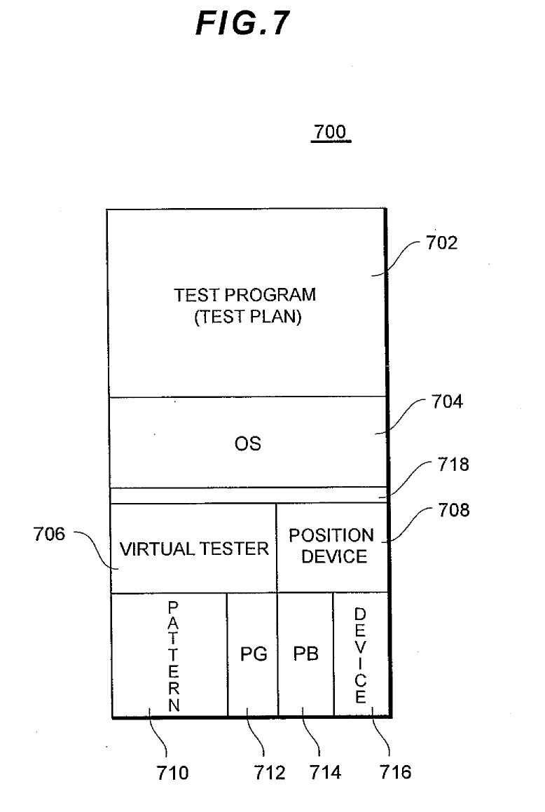

FIG. 7 is a diagram showing an example of a software architecture 700 of an FSM according to an embodiment of the present invention. The software architecture 700 includes a test program (test plan program) 702, an operating system (OS) 704, a virtual tester 706, a virtual device 708, a pattern program 710, a pattern generator (PG) 712, a performance board (PB) 714, and a device plan 716. The test program 702 and the operating system 704 correspond to the system controller 102. The virtual tester 706 and the virtual device 708 correspond to the emulator 140. The PB 714 corresponds to the load board 114. The operating system 704, the virtual tester 706 and the virtual device 708 are connected via the communication channel 718 or the like.

In the FSM, the test program 702 is transferred to the virtual tester 706 via the communication channel 718 to be operated on the virtual tester 706. In the virtual tester 706, an object file of the pattern program 710 is first loaded to the memory of the pattern generator 712 in response to a command from the test program 702. Then, a command for operating the pattern generator 712 in the test program 702 is executed to start generating the pattern, which is input into the virtual device 708. In the virtual device 708, output for the input pattern is simulated based on a device plan 716 created according to a logical circuit of the DUT 112. The virtual tester 706 compares an output result of the virtual device 708 with an expected value pattern to confirm the test.

In the FSM, a large amount of resources is needed for storage such as a CPU, a memory, a hard disk and the like. For example, as the pattern program 710 is a very large data generally with several giga (G)-byte order and the device plan 716 is a very large data with several 100 mega (M)-byte order, it takes around one day for the pattern program 710 and the device plan 716 to be loaded to the emulator 140 to be in the standby state where the test program 702 can be debugged. With restriction on the memory capacity, simulation on the pattern program 710, the pattern generator 712, and the virtual device 708 cannot be performed only by memory access and requires access to the storage. That requires much time in simulation. In the FSM, communication between the operating system 704 and the emulator 140 (the virtual tester 706 and the virtual device 708) is slow. From these reasons, it takes a long time in debugging on the test plan program in the FSM as it needs about a week or so for the test.

Also in the FSM, emulation is performed based on the device plan 716 created according to the logical circuit of the DUT 112. As such, it is difficult to arbitrarily set results (pass/fail) of individual tests. As a result of a predetermined test executed on the DUT 112, it is determined that the Response is ‘Pass’ in the simulation system 120 if the output result from the DUT 112 is within the expected value. If the output result from the DUT 112 is outside the expected value, it is determined that the Response is ‘Fail’. As such a result which seldom occurs cannot be generated, it is difficult to secure durability of the test plan program.

### (LSM)

The LSM is a simulation mode for performing verification on activities of the test plan program faster than in the FSM by arbitrarily generating a Response in the offline environment. The LSM provides a function of performing verification on the test plan centering on the test flow within an appropriate time in the offline environment, and also provides means for checking almost all the processing procedures in the test class in the offline environment.

In the embodiment, a pattern load omitting function, a test execution omitting function, and a Response Injection function are included in the LSM. The pattern load omitting function implements fast loading by omitting loading the pattern in loading the test plan program. The test execution omitting function speeds up the execution of the test plan program in the offline by skipping the execution of the pattern and the DC measurements. The Response Injection function is a function of changing the expected value from outside to the device plan that operates on the offline emulator. With these functions, verification of the test plan program can be performed fast based on the Response Data specified by the user as only minimum communication is performed with the emulator 140 in verifying the test plan program in the LSM.

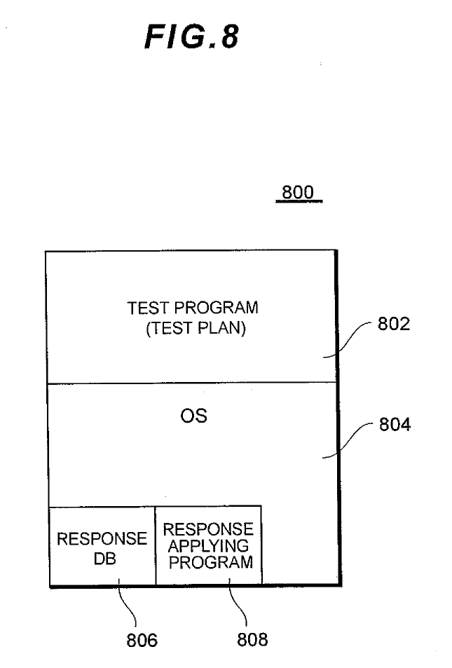

FIG. 8 is a diagram showing an example of a software architecture 800 of the LSM according to an embodiment of the present invention. The software architecture 800 includes a test program (test plan program) 802, an operating system (OS) 804, a Response DB 806, and a Response applying program 808. The Response DB 806 corresponds to the Response DB 132, storing Response Data read from the Response Data File 136 set by a user. The Response applying program 808 serves as the framework 130 when it is executed. It has a function of returning an output result of the DUT or the DUT model corresponding to a test item in response to the operation of the test plan program based on the Response data stored in the Response DB 806.

Now, a Response Injection function of the LSM will be described based on an embodiment of the present invention.

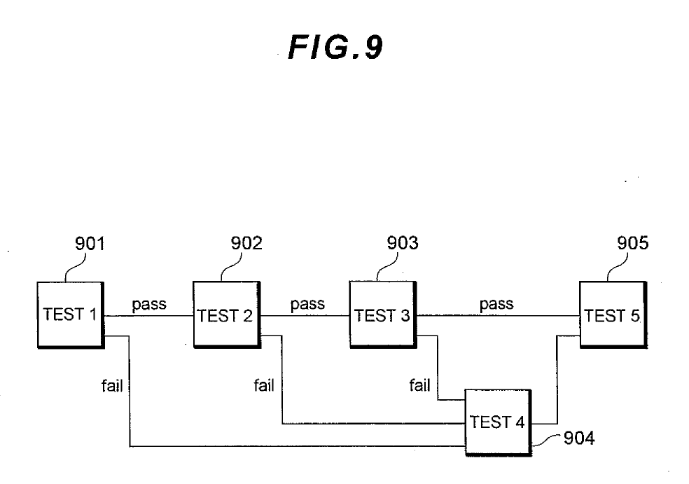

FIG. 9 is a diagram showing a test flow of a test plan program in an embodiment of the present invention. As shown in FIG. 9, the test plan program of the embodiment consists of five kinds of test items (test 901, test 902, test 903, test 904 and test 905). In this test plan, first the test 901 is performed on the DUT. If the test 901 is passed, the test 902 is performed, and if the test 902 is passed, the test 903 is performed, then if the test 903 is passed, the test 905 is performed. If any of the tests 901, 902 and 903 is failed, the test 904 is performed, and finally the test 905 is performed.

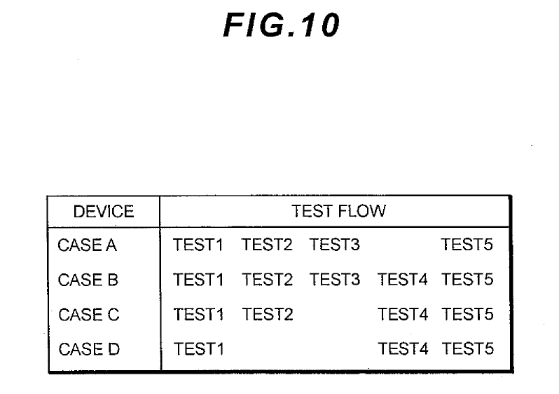

FIG. 10 is a diagram showing an example of Response Data for verifying the test plan program shown in FIG. 9 by the LSM. In the Response Data shown in FIG. 10, it is assumed that devices with four different characteristics are used and a Response for an individual test is set for each device. In the case A, it is assumed that a device that passes all of the tests 901, 902 and 903 is used. In the case B, it is assumed that a device that passes the tests 901 and 902 a fails the test 903 is used. In the case C, it is assumed that a device that passes the test 901 and fails the test 902 is used. In the case D, it is assumed that a device that fails the test 901 is used.

At least places where the test is failed are preferably specified for the Response Data. The test items which are not specified as ‘Fail’ are considered as ‘Pass’. Specifically, in the example shown in FIG. 10, all the tests are passed in the case A, thus, nothing needs to be specified. In the case B, that the test 903 is failed is specified. In the case C, that the test 902 is failed is specified. In the case D, that the test 901 is failed is specified. When the test plan program is verified, the Response applying program 808 references the Response DB 806 for predetermined test items, and if the test items are specified as failed, it injects ‘Fail’ as an output result for the device for the test items. If nothing is specified, it injects ‘Pass’ as an output result for the device for the test items.

Now, the operations of the LSM will be described with reference to the embodiment shown in FIG. 8 to FIG. 10. First, the user creates the Response Data according to the test flow of the test plan program to be verified. In the test plan shown in FIG. 9, four routes of tests to be assumed are considered. It is preferable to assume four virtual devices to cover the four routes as shown in FIG. 10 as the Response Data. Next, the test plan program 802 is loaded to the framework 130 and the Response Data is loaded to the Response DB 806, and then the simulation by the LSM is performed. In the LSM, the output result of the device is taken in via the OS 804 according to the operation of the test plan program. For the output result, the Response applying program 808 injects either ‘Pass’ or ‘Fail’ by searching the Response DB 806. If the test plan has a plurality of test routes and assumes a plurality of virtual devices as the Response Data, a plurality of test routes can be verified by verifying the virtual devices in order.

For example, in the embodiment, first, the case A is set as a virtual device and the test plan program operates. Then, the test 901 is performed and ‘Pass’ is injected as the output result of the device for the test 901. As shown in FIG. 9, in the test plan program, if the test 901 is passed, the flow proceeds to the test 902 and the test 902 is performed. Then, ‘Pass’ is injected as the output result of the device for the test 902, and the flow proceeds to the test 903. In the case A, ‘Pass’ is also injected as the output result of the device for the test 903, and the flow proceeds to the test 905. In this manner, the route through which all the tests are passed is verified in the case A.

Next, the case B is set as a virtual device and the tests are performed in the same manner. In the case B, ‘Pass’ is injected for the test 901, and the flow proceeds to the test 902 and ‘Pass’ is injected for the test 902, and the flow proceeds to the test 903. In the case B, ‘Fail’ is injected for the test 903, and the flow proceeds to the test 904. In this manner, the route through which the test 903 is failed is verified in the case B.

Next, the case C is set as a virtual device and the tests are performed in the same manner. In the case C, ‘Pass’ is injected for the test 901, and the flow proceeds to the test 902. ‘Fail’ is injected for the test 902, and the flow proceeds to the test 904. In this manner, the route through which the test 902 is failed is verified in the case C.

Finally, the case D is set as a virtual device and the tests are performed in the same manner in the embodiment. In the case D, ‘Fail’ is injected for the test 901, and the flow proceeds to the test 904. In this manner, the route through which the test 901 is failed is verified in the case D.

As mentioned above, in the LSM, neither the pattern program and the like need to be loaded nor the DUT model needs to be emulated in verifying the test plan program. That enables verification faster than in the FSM. The test plan program typically includes a plurality of branches with a plurality of test items so that it has a plurality of test routes. In the LSM, a user can specify any output result for each test item. Accordingly, the user can easily verify any branches and test routes. The user can also easily verify all the test flows of the test plan by creating the Response Data that covers all the possible test routes.

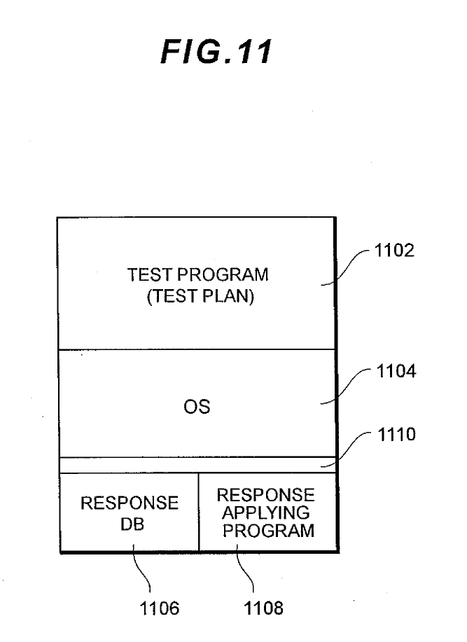

FIG. 11 is a diagram showing another example of a software architecture 1100 of the LSM according to an embodiment of the present invention. The software architecture 1100 contains a test program (test plan program) 1102 and an operating system (OS) 1104, and has the Response DB 1106 and the Response applying program 1108 outside the OS, which are connected by the communication route 1110. The LSM is also executable in the software architecture shown in FIG. 11, however, it results in a configuration to have the Response DB 1106 and the Response applying program 1108 outside the OS (e.g., an emulator 140). Thus, the processing speed is slower in that case than in the case where the Response DB 1106 and the Response applying program 1108 are in the OS as shown in FIG. 8.

### (Use of Device Characteristic Measurements)

As mentioned above, in the LSM, Response Data for verifying a predetermined test route can be created. That means that a device with desired characteristics can be set as the DUT model for verification. Here, a user can explicitly set the device characteristics or the measurements of real device characteristics measured in the test equipment 100 can be used. Specifically, characteristics of the real device is measured in the test equipment 100 and the Response Data is created based on the measurements so that a device with the same characteristics as those of the real device can be reproduced when the test plan program is verified in the LSM.

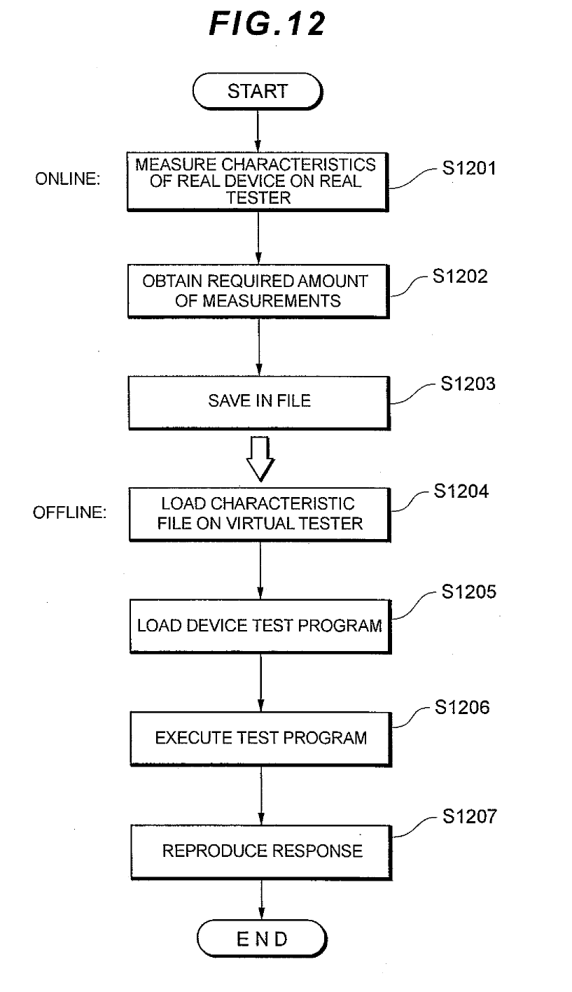

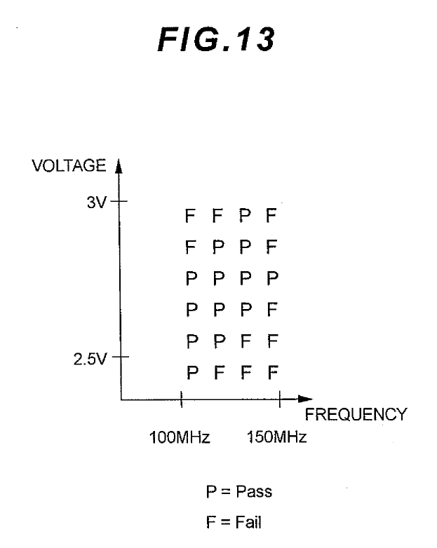

The processing of reflecting the measurements of the real device to the LSM will be described with reference to FIG. 12 and FIG. 13. FIG. 12 is a flowchart showing a flow of processing for reproducing measurements of a real device in an offline environment according to an embodiment of the present invention. FIG. 13 is a diagram showing an example of an expected value at a point in a device characteristic space that is formed by voltage and frequency.

First, characteristics of the real device (DUT) are measured using the test equipment 100 in an offline Response Data is obtained appropriately from the measurements (S1202), the Response Data is created based on the obtained measurements to be saved in the Response Data file (S1203).

For example, when a real device is measured and if the result measured when the voltage is 2.5 V and the frequency is 100 MHz is ‘Pass’, Response data indicating that the Response at the voltage of 2.5 V and the frequency of 100 MHz is ‘Pass’ is created based on the measurement. The Response Data in which expected values (pass/fail) at points in the device characteristic space are set in a matrix can be created using the measurements of the real device as shown in FIG. 13. Although FIG. 13 shows an example in which the Response Data is set in a two-dimensional matrix, the Response Data can be set in a one or more dimensional matrix.

Next, the test plan is verified by using the test equipment 100 in the offline environment. First, the Response Data file that is created by online measurement performed on the simulation system 120 is loaded (11204). Then, the test plan program is loaded (11205). When the loaded test plan program is executed (S1206), the same Response as that in the real device is reproduced in the offline environment (S1207).

For example, if the test plan program is executed in the simulation in the offline environment in the previous mentioned case, the output from the DUT model (device) when the voltage is 2.5 V and the frequency is 100 MHz is ‘Pass’ as for the real device. The measurements for the real device can be reproduced in the LSM as the Response Data is created based on the measurements for the real device.

In this manner, in the embodiment, the measurements obtained from the real device in the online environment are reproduced in the offline environment so that the test plan program can be verified. In the real device, the frequency characteristics do not necessarily depend on the voltage characteristics as shown in FIG. 13. Then, the Response Data can be created as in the real device by verifying the test plan program using the measurements obtained from the real device.

A device that is failed for a desired test item can be set by appropriately correcting the measurements obtained from the real device. That enables a user to verify the test plan program by freely creating the Response Data with a defective and a failure contained. In the embodiment, the voltage and the frequency are exemplified for device characteristics, though, it is a matter of course that the device characteristics are not limited to them and any number of any characteristics may be used.

A specific example for realizing the Response Injection function of the simulation system 120 according to the embodiment will be described below.

### (Outline of the Response Injection Function)

The Response Injection function includes such functions as pattern specification of DUT output, parameter specification of DUT output, fail specification of patterns and a pattern list, fail specification of Burst Pattern, forcible specification of DC measurement, forcible specification of a result of executing Test Instance and the like. The pattern specification of DUT output and the parameter specification of DUT output are functions of inputting a behavior of DUT. Inputting them enables offline debugging according to the operation of the real DUT.

### (Setting of the Response Data)

The Response Data file 136 is specified when the test plan program DLL 134 is loaded and the Response Data is loaded to the Response DB 132. The loading to the Response Data file 136 may be explicitly performed via input means of the system controller 102. The Response Data may be loaded, added or deleted by using the script commands for controlling the LSM or the Response Data file 136 may be loaded with the API function.

### (Structure of the Response Data)

Any Response Data may be set at any timing by using three functions below to set the Response Data: First, a function of specifying the Response Data that can set a piece of the Response Data. Next, a function of defining a Response group for grouping the Response Data. Here, the Response group is a unit for applying (reflecting) the Response Data to the DUT. Finally, a function of defining DUT that can specify different Response Data for each objective DUT by the DUT simultaneous measurement between the site controllers 104 and the DUT simultaneous measurement in the site controller 104. Correlation between the DUTFlow/Flow and the Response group can be defined for each DUT by using a DUT reserved word and a DUT number defined in a Socket File. Thus, the DUTFlow/Flow can be allocated to the Response group independently for each DUT.

The DUT defining function can associate the DUT defined in the Socket File and the Response group. Specifically, which DUT which Response data is applied to can be specified. The characteristics of the DUT definition will be shown below.

First, the DUT number defined in the Socket File can be specified for the DUT number specified in the DUT definition. The Response for the specified DUT can be specified. That kind of DUT definition needs to be defined for the DUT to be specified with the Response. The DUT without the DUT definition operates by the default Response.

Second, the Response group is allocated to the DUTFlow/Flow identifier of OTPL language. That allows a Response group to be allocated for each DUTFlow/Flow instance. An DUTFlow/Flow instance treated as a sub-flow may be an objective DUTFlow/Flow. If no Response Data (ApplySequence) is described in a sub-flow, the Response Data is inherited from the higher flow.

Third, if two or more cases of specification to the DUTFlow/Flow instance match at the same time from a viewpoint of the flow item currently executed, only the Response group finally decided to be applied is applied.

Fourth, a plurality of the Response group can be allocated to the DUTFlow/Flow instance. Each time when the specified DUTFlow/Flow instance has executed, the flow goes to the next Response group to be applied in order. When the final Response group is applied, the flow returns to the top Response group.

Finally, different pieces of Response Data between simultaneous measurement DUTs in the site controller 104 and between the DUTs between the site controller 104 are specified. Specifically, any Response group may be specified to each DUT without regard of the site controller 104.

### (Pattern Specification of DUT Output)

In the LSM, the DUT output pattern can be described. That can be considered as the same as the expected value of the pattern file, though, that can be input as the Response Data in the LSM. A function of specifying the DUT output pattern influences behaviors shown below.

First, a fail occurs when Fail is specified to a pattern and a pattern list. The kinds of the Fail are influenced. Whether a strobe for comparing H or L is ‘Fail’ is changed.

Second, data that can be obtained in the DFM is influenced. Whether the H side or the L side is ‘Fail’ for capture data at a place of fail specification of the DFM is changed.

That is, a specified value for specifying the DUT output pattern does not directly influence the result of the LSM. That is counted only when that is combined with a fail specifying function of a pattern and a pattern list or fail specification of the DFM.

For specifying a pattern of the DUT output, a defined value (a default value) has been originally used. The default value is ‘H’. If no user specification is done, the default value satisfies all the vector address spaces in which the Response Injection function operates. A user may specify a default value for each pin. That description can be input as the Response Data.

There is a function for a user to explicitly specify a DUT output pattern. For the function, the starting position for specifying a DUT output pattern and sequence of the DUT output from the starting position need to be specified.

In the embodiment, output characters of ‘H’, ‘L’ and ‘Z’ may be used for specifying the DUT output pattern. For ‘H’, a digital signal corresponding to one is output. For ‘L’, a digital signal corresponding to zero is output. For ‘Z’, device output resistance corresponds to the high impedance.

One character is used for an occasion of comparing at the tester side. Therefore, if a plurality of times of comparing are present for a single test cycle for each pin, the DUT output characters is needed by the time of comparison for a single test cycle. If the DUT output is actually described, a plurality of output characters can be arranged at a time. The number of specifying occasions of the output characters is not limited.

### (Specification of DUT Output Parameters)

In specifying the DUT output parameters, the Response in a certain condition for the DUT can be defined. That is, a Response which is only effective under a certain condition can be independently defined. For the condition, a predetermined parameter in the tester module can be used.

The operating principle is shown below. A user of the function specifies one or two input parameters. Behavior for the specified input parameter is defined by specifying the Response group. Any Response group can be specified for that.

TABLE 1

```
RDGroup PatFail
{
  RD TestInstance TestItem1 BurstNumber * # All Burst is Fail
}
RDGroup DUTSpecify
{
  DUTParams
  {
    XParam tmapBlockname:Domain1:wfsname
    Period 10nS # Input parameter 1
    YParam InputPins VForce 1.2V # Input parameter 2
    TargetResponse PatFail # Target Response
  }
}
```

In the example shown in Table 1, the Response Data is defined by RDGroup. DUT output parameters are enabled to be specified for ‘TestItem 1’ Test Instance. At the ‘InputPins’ pin, a result of executing the patterns is failed if VForce is 1.2 V and Period of ‘Domain 1’ domain is 10 nsec.

Details are shown below. For specifying an input parameter, the reserved words XParam and YParam are used. Two of them can be specified at a time. If one of them is used, XParam is used. A hardware parameter is specified for pin, pin group, domain. For the input parameter, the hardware parameter for the tester, a defining variable in SpecificationSet of OTPL, or a user-defined variable of OTPL can be specified. The input parameter that can be specified is voltage values of DPS, Test Period values, compared voltage values (VOH, VOL) of Output Pin (Comparator Pin) of Digital Module, output voltages (VIH, VIL) from Input Pin of Digital Module, Timing values of Timing Edge and the like as the hardware parameters. The input parameter is one of the user-defined variables that can be referenced as a defined variable.

Combination of the input parameters for specifying two input parameters is not limited. If the input condition is satisfied, only one Response group is applied.

Correlation between the parameters to be input and the Response group, which is Responses, can be serially defined. Although behavior at a point is defined in specifying the DUT output parameters as mentioned in Table 1, serial inputting functions of specifying serial behavior of DUTs in a certain parameter range may be included.

The serial inputting functions are shown below. For the input parameters, starting values, step values, number of steps are specified. The Responses corresponding to all the input parameters need to be specified. If the number of specified Response groups is less than the number of steps, the finally applied Response groups are kept applied. The same Response group may be serially specified for simplicity. A serial specifying descriptor is used for that. Negative numbers may be used for a step interval and a starting value. For the order of specifying TargetResponse in the case where two input parameters are specified, parameters for XParam are described for all the steps for an initial value of YParam. Next, XParam are described for all the steps for the next step value of YParam. Lines may be changed in a block of TargetResponse.

For one-dimensional format, one of the parameters can be specified. For two-dimensional format, any combination of two parameters can be applied. The example will be shown in Table 2.

TABLE 2

```
RDGroup PatFail
{
  RD TestInstance TestItem1 BurstNumber * # All Burst is Fail
}
RDGroup PatPass
{
  RD TestInstance TestItem1 BurstNumber * PassFail PASS
}
RDGroup DUTSpecify
{
  DUTParams
  {
    XParam tmapBlockname:Domain1:wfsname Period
    10nS.1nS,10 # Input parameter 1
    TargetResponse PatFail/5 PatPass
  }
}
```

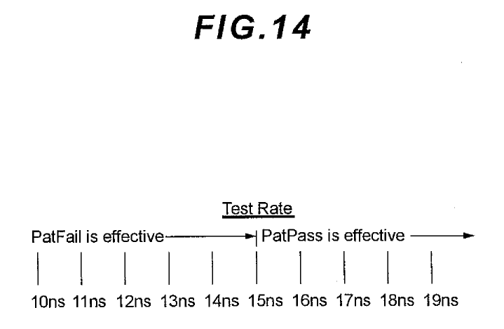

FIG. 14 is a diagram showing an example of the Response to be injected to an example shown in Table 2. As shown in FIG. 14, in the serially specifying function, specified Response groups are serially effective. The nearest Response groups are effective to the next step. For example, if Period of 15.1 nsec is applied to the example shown in Table 2, ‘PatPass’ Response group is effective and the pattern executed result is ‘Pass’.

As shown in Table 3, if two pieces of input data are prepared and a character map function for the Response Data is used, the behavior of the DUT can be input as the Response Data in two-dimensional Shmoo format.

```
TABLE 3
RDGroup PatFail
{
  RD TestInstance TestItem1 BurstNumber * # All Burst is Fail
}
RDGroup PatPass
{
  RD TestInstance TestItem1 BurstNumber * PassFail PASS
}
RDGroup DUTSpecify
{
  DUTParams
  {
    XParam tmapBlockname:Domain1:wfsname Period
    10nS,1nS,5 # Input parameter 1
    YParam InputPins VForce 1V,−0.1V,4 # Input parameter 2
    CharMap * PatPass
    CharMap . PatFail
    TargetResponse
    {
      ***..
      **...
      *....
      .....
    }
  }
}
```

The character map function can map any Response group to characters or positive numbers by using CharMap reserved word. The mapped characters can be used in that TargetResponse.

### (Fail Specification of a Pattern and a Pattern List)

Fail specification of a pattern and a pattern list is a method for forcibly specifying ‘fail’ to a place based on a pattern list file and a pattern file as a base point. The number of specification is not limited.

That function can generate ‘fail’ for a particular pattern in the operation in the test plan program. In that case, it can also generate ‘fail’ by specifying a Pin, Domain, or Cycle, Address, Label. It can generate ‘fail’ for a particular pattern list. In that case, it can also generate ‘fail’ by specifying a Pin, Domain, or Cycle, Address, Label of a belonging pattern. It also specifies ‘fail’ to the DEN content.

A function of specifying ‘fail’ for the DFM is an extended version of a function of generating ‘fail’ for a particular pattern list. If ‘fail’ is generated in a particular pattern or a particular pattern list, not only ‘fail’ is also recorded at a corresponding place in the DFM but also the DEM content can be positively controlled. Specification of ‘fail’ for a pattern and a pattern list is a function of generating ‘fail’. The reason why it was specified as ‘fail’ is decided by the output content of the DUT in specifying the DUT output patterns.

### (Function of Generating ‘Fail’ for a Pattern and a Pattern List)

Immediately after loading the test plan program or immediately after loading the Response Data, a place for specifying the Response is determined. A method for specifying the function will be shown. Expected Responses are ‘total fail’ and ‘pin fail’ for an objective pattern list.

For specifying ‘fail’ for a pattern and a pattern list, a method for specifying all the fail places is taken by applying a single function whose condition of specifying a fail place is the most complicated. Only two functions such as three types of specification such as specification of a pin, a particular pattern in the pattern list, and an address; and three types of specification such as specification of a pin, a particular pattern in the pattern list, and a cycle are prepared. These are called a basic function of pattern specification. A user can specify a place with any desired unit by applying a function of specifying a pattern.

A function of obtaining a result of a pin is influenced by a DUT output pattern specification. A character value for the DUT output pattern specification corresponding to a fail position list and its result value can be summarized as below. If the DUT output at a place to be failed is ‘H’, a result is obtained by PinResultHighFail. If the DUT output at a place to be failed is ‘L’, a result is obtained by PinResultLowFail. If the DUT output at a place to be failed is ‘Z’, a result is obtained by PinResultHighFail.

### (Fail Specification for the DFM)

In the LSM, a place where fail is to occur can be specified by the Response Data for the capture data of the DFM. That function is the same as the function of generating fail to a pattern and a pattern list except that a plurality of fail occurrences can be specified at a time with that function. That function can be used as a function of controlling an obtained content of the DFM by specifying a plurality of fail positions. A data content that can be obtained in the DFM for the fail specified place reflects the result of the DUT output pattern specification. If the content of the DUT output pattern specification is ‘H’ and fail is specified to the place, the strobe for comparing H can obtain the failed data. All the other places without specification are treated as ‘Pass’ and the corresponding data can be obtained.

For fail specification, a starting position for generating fail and a fail position list need to be specified. For specifying the starting position for generating fail, the function shown in the fail specification for a pattern and a pattern list is used. With sequence specification for the fail position list added, fail can be specified to the DFM. If no fail position list is specified, the same operation is taken as that for specifying fail for only one comparison of specifying places.

Now, a method for specifying a fail position list will be shown. The fail specifying method is a method for listing numbers of places where fail is occurring on the assumption that the starting position is zero. A plurality of places can be specified for an occasion of specification. An exemplary specifying method will be shown.

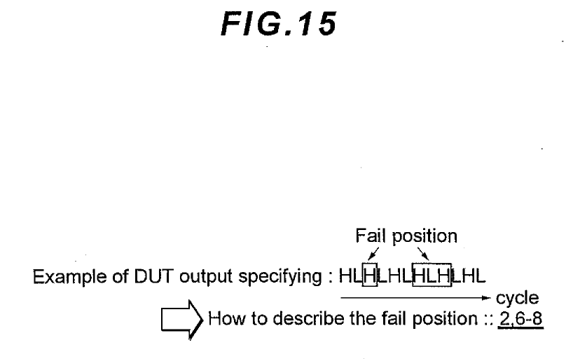

FIG. 15 is a diagram showing an example of specifying fail according to an embodiment of the present invention. In FIG. 15, it is specified that the list is 6 to 8 in the positions notation and one comparison is 2 in the positions notation.

For specifying fail to the DEM, the function below is also considered.

The fail specification to the DEN influences Total Result and Pin Result in Test Item. Fail is generated so as to match the fail on the DEM with a burst executing unit or a Pin unit.

The type of fails that can be obtained in fail specification to the DFM depends on the DUT output specification in the DUT output pattern specification. If no DUT output is explicitly specified, fail for ‘H’output, which is a default value for the DUT output specification, occurs. That is, the type of fail which can be detected in the DFM is ‘H’ fail.

### (Forcible Specification of DC Measurements)

In the forcible specification of DC measurements in the DPS and PMU, a voltage value and a current value of the DC measurements can be specified from the Result Data. A plurality of current sampling values can be also specified in the form of arrangement. If the plurality of measurements is given as arrangement data, the DC measurements can be obtained as the current sampling values. As different usage, the DC measurements can be obtained as measurements for a time of voltage measuring and current measuring. In that case, specified values are adopted as measurements in order from the top for each time of measuring.

If no Response Data is specified in the forcible specification of the voltage and current measurements, default values are preferably OV for the voltage measurement and OA for the current measurement respectively. All pieces of the current sampling data, which can be obtained for one, are OA. Default values for pass/fail determination is preferably Pass. If the Response Data for the DC value is set for Test Instance, the default values are invalidated and the determination is performed by the obtained DC values.

### (Forcible Specification of the Test Instance Execution Result)

In the LSM, the Test Instance execution result can be forcibly specified. The Test Instance name is specified and Result Status, which is the Test Instance execution result for the name, can be specified.

The present invention is not limited to the abovementioned embodiments and various modifications are possible without departing from the spirit of the present invention. Thus, the abovementioned embodiments are mere examples and should not be construed to limit the invention. Each of the processing steps of the abovementioned embodiments may be executed in different orders or in parallel unless they are not inconsistent with the processing.

What is claimed is:

1. A simulation method comprising the steps of:
measuring a predetermined characteristic from a real device by using test equipment that supplies a test signal to a device-under-test (DUT);
saving Response Data generated from measurements obtained by said measuring in a file; and
verifying activities of a test plan program in a simulation system that simulates said test equipment by using the Response Data saved in said file.

2. The simulation method according to claim 1, wherein
said Response Data includes:
measurements for one or more characteristics and an output result for a predetermined test item.

3. The simulation method according to claim 2, wherein
said output result is such that
an output result from a real device for said predetermined test item is set by pass/fail.

4. The simulation method according to claim 3, wherein
at said step of verifying,
if an output result is not set in said Response Data, the output result is considered as pass.

5. The simulation method according to claim 1, wherein
said Response Data is
generated based on the measurements obtained from one or more real device.

6. The simulation method according to claim 1, further comprising
the step for a user to change the Response Data saved in said file as desired.

7. The simulation method according to claim 1, wherein
said Response Data is such that
the output results are arranged in a matrix for one or more characteristics.

8. The simulation method according to claim 1, wherein
at said step of verifying,
activities of said test plan program is verified without loading a pattern program.

9. The simulation method according to claim 1, wherein said step of verifying comprises the steps of:
loading the Response Data from said file to said simulation system;
loading said test plan program to said simulation system;
executing said test plan program; and
verifying activities of said test plan program by reproducing said measurements on said simulation system.

10. A simulation system that verifies activities of a test plan program that is interpreted by test equipment that supplies a test signal to a device-under-test (DUT), comprising:
a file for measuring a predetermined characteristic from a real device by using said test equipment and saving Response Data generated from the measurements obtained by said measuring; and
a framework for verifying the activities of said test plan program by using the Response Data read out from said file.

11. The simulation system according to claim 10, wherein
said Response Data includes:
measurements for one or more characteristics and an output result for a predetermined test item.

12. The simulation system according to claim 11, wherein
said output result is such that
an output result from a real device for said predetermined test item is set by pass/fail.

13. The simulation system according to claim 12, wherein
said framework is such that
if an output result is not set in said Response Data, the output result is considered as pass.

14. The simulation system according to claim 10, wherein
said Response Data is
generated based on the measurements obtained from one or more real device.

15. The simulation system according to claim 10, wherein
a user can change the Response Data saved in said file as desired.

16. The simulation system according to claim 10, wherein
said Response Data is such that
the output results are arranged in a one-dimensional or two or more dimensional matrix for one or more characteristics.

17. A computer program product for causing a computer to execute the steps of:
measuring a predetermined characteristic from a real device by using test equipment that supplies a test signal to a device-under-test (DUT);
saving Response Data generated from measurements obtained by said measuring in a file; and
verifying activities of a test plan program by simulating said test equipment by using the Response Data saved in said file.

18. The computer program product according to claim 17, wherein
said Response Data includes:
measurements for one or more characteristics and an output result for a predetermined test item.

19. The computer program product according to claim 18, wherein
said output result is such that
an output result from a real device for said predetermined test item is set by pass/fail.

20. The computer program product according to claim 19, wherein
at said step of verifying,
if an output result is not set in said Response Data, the output result is considered as pass.
